(19) United States
(12) Patent Application Publication
(10) Pub. No.: US 2026/0080306 A1
(43) Pub. Date: Mar. 19, 2026

(54) METHOD FOR AUTOMATIC DATA AUGMENTATION AND ELECTRONIC DEVICE

(71) Applicant: SAMSUNG ELECTRONICS CO., LTD., Suwon-si (KR)

(72) Inventors: Zhicong XIE, Suwon-si (KR); Heng LIU, Suwon-si (KR); Ruixiang LU, Suwon-si (KR); Bodon JEONG, Suwon-si (KR); Bumjun KIM, Suwon-si (KR); Jungsoo KIM, Suwon-si (KR); Ning LI, Suwon-si (KR)

(73) Assignee: SAMSUNG ELECTRONICS CO., LTD., Suwon-si (KR)

(21) Appl. No.: 18/974,151

(22) Filed: Dec. 9, 2024

(30) Foreign Application Priority Data
Sep. 19, 2024 (CN) 202411310809.4

(51) Int. Cl. G06N 20/00

(52) U.S. Cl. CPC G06N 20/00

(57) ABSTRACT

A method for automatic data augmentation, including: determining a plurality of hyper-parameters corresponding to a plurality of sub-models using a central processing unit (CPU); training the plurality of sub-models based on the plurality of hyper-parameters using a plurality of storage devices and a plurality of graphics processing units (GPUs); and updating at least one sub-model from among the trained plurality of sub-models and at least one hyper-parameter corresponding to the updated at least one sub-model using the CPU, wherein the plurality of sub-models are trained for a first predetermined number of epochs, and wherein, during each epoch, the training includes: preprocessing an original dataset based on the plurality of hyper-parameters to generate a plurality of preprocessed datasets corresponding to the plurality of hyper-parameters using the plurality of storage devices; and training the plurality of sub-models based on the plurality of preprocessed datasets using the plurality of GPUs.

### CROSS-REFERENCE TO RELATED APPLICATION

This application is based on and claims priority under 35 U.S. C. § 119 to Chinese Patent Application No. 202411310809.4, filed on Sep. 19, 2024, in the China National Intellectual Property Administration, the disclosure of which is incorporated by reference herein in its entirety.

### BACKGROUND

### 1. Field

The disclosure relates to a field of machine learning, and more particularly, to a method for automatic data augmentation and an electronic device.

### 2. Description of Related Art

According to some approaches for performing deep learning, a model may be continuously trained with a large number of datasets to improve generalization ability. In a field of computer vision, automatic data augmentation methods may be employed to expand the datasets. The automatic data augmentation methods may include preprocessing operations, for example performing a preprocessing on an original dataset. However, there is a need for a technique to improve efficiency of the preprocessing operations of automatic data augmentation methods, and to improve efficiency of training the model.

### SUMMARY

Provided is a method for automatic data augmentation and an electronic device, which may at least improve the efficiency of the preprocessing operations of the automatic data augmentation methods and the efficiency of training the model.

Additional aspects will be set forth in part in the description which follows and, in part, will be apparent from the description, or may be learned by practice of the presented embodiments.

In accordance with an aspect of the disclosure, a method for automatic data augmentation includes: determining a plurality of hyper-parameters corresponding to a plurality of sub-models using a central processing unit (CPU); training the plurality of sub-models based on the plurality of hyper-parameters using a plurality of storage devices and a plurality of graphics processing units (GPUs); and updating at least one sub-model from among the trained plurality of sub-models and at least one hyper-parameter corresponding to the updated at least one sub-model using the CPU, wherein the plurality of sub-models are trained for a first predetermined number of epochs, and wherein, during each epoch from among the first predetermined number of epochs, the training includes: preprocessing an original dataset based on the plurality of hyper-parameters to generate a plurality of preprocessed datasets corresponding to the plurality of hyper-parameters using the plurality of storage devices; and training the plurality of sub-models based on the plurality of preprocessed datasets using the plurality of GPUs.

In accordance with an aspect of the disclosure, an electronic device includes: a central processing unit (CPU) configured to determine a plurality of hyper-parameters corresponding to a plurality of sub-models; and a plurality of storage devices and a plurality of graphics processing units (GPUs) configured to train the plurality of sub-models based on the plurality of hyper-parameters, wherein the CPU is further configured to update at least one sub-model from among the trained plurality of sub-models and at least one hyper-parameter corresponding to the updated at least one sub-model, wherein the plurality of are trained for a first predetermined number of epochs, and wherein, during each epoch from among the first predetermined number of epochs, the plurality of storage devices are further configured to perform preprocessing on an original dataset based on the plurality of hyper-parameters, to generate a plurality of preprocessed datasets corresponding to the plurality of hyper-parameters respectively, and wherein, during the each epoch, the plurality of GPUs are further configured to train the plurality of sub-models based on the plurality of preprocessed datasets.

In accordance with an aspect of the disclosure, a system to which storage devices are applied, includes: a main processor; a memory; a storage device; and a plurality of graphics processing units (GPUs), wherein the main processor is configured to determine a plurality of hyper-parameters corresponding to a plurality of sub-models, wherein the storage device and the plurality of GPUs are configured to train the plurality of sub-models based on the plurality of hyper-parameters, wherein the main processor is further configured to update at least one sub-model from among the trained plurality of sub-models and at least one hyper-parameter corresponding to the updated at least one sub-model, and wherein the plurality of sub-models are trained for a first predetermined number of epochs, wherein, during each epoch of the first predetermined number of epochs, the storage device is further configured to perform preprocessing on an original dataset based on the plurality of hyper-parameters to generate a plurality of preprocessed datasets corresponding to the plurality of hyper-parameters, and wherein, during the each epoch, the plurality of GPUs are further configured to train the plurality of sub-models based on the plurality of preprocessed datasets.

In accordance with an aspect of the disclosure, a host storage system includes: a host including a central processing unit (CPU) and a plurality of graphics processing units (GPUs); and a storage device, wherein the CPU is configured to determine a plurality of hyper-parameters corresponding to a plurality of sub-models, wherein the storage device and the plurality of GPUs are configured to train the plurality of sub-models based on the plurality of hyper-parameters, wherein the CPU is further configured to update at least one sub-model from among the trained plurality of sub-models and at least one hyper-parameter corresponding to the updated at least one sub-model, wherein the plurality of sub-models are trained for a first predetermined number of epochs, wherein, during each epoch of the first predetermined number of epochs, the storage device is further configured to perform preprocessing on an original dataset based on the plurality of hyper-parameters to generate a plurality of preprocessed datasets corresponding to the plurality of hyper-parameters; and wherein, during the each epoch, the plurality of GPUs are further configured to train the plurality of sub-models based on the plurality of preprocessed datasets.

In accordance with an aspect of the disclosure, a Universal Flash Storage (UFS) system includes: a UFS host including a central processing unit (CPU) and a plurality of graphics processing units (GPUs); a UFS device; and a UFS interface configured to communicate between the UFS host and the UFS device, wherein the CPU is configured to determine a plurality of hyper-parameters corresponding to a plurality of sub-models, wherein the UFS device and the plurality of GPUs are configured to train the plurality of sub-models based on the plurality of hyper-parameters, wherein the CPU is further configured to update at least one sub-model from among the trained plurality of sub-models and at least one hyper-parameter corresponding to the updated at least one sub-model, and wherein the plurality of sub-models are trained for a first predetermined number of epochs, wherein during each epoch from among the first predetermined number of epochs, the UFS device is further configured to preprocess an original dataset based on the plurality of hyper-parameters to generate a plurality of preprocessed datasets corresponding to the plurality of hyper-parameters; and wherein during the each epoch, the plurality of GPUs are further configured to train the plurality of sub-models based on the plurality of preprocessed datasets.

In accordance with an aspect of the disclosure, a data center system includes: a plurality of application servers; and a plurality of storage servers, wherein at least one application server of the plurality of application servers includes a central processing unit (CPU), a plurality of storage devices and a plurality of graphics processing units (GPUs), wherein the CPU is configured to determine a plurality of hyper-parameters corresponding to a plurality of sub-models, wherein the plurality of storage devices and the plurality of GPUs are configured to train the plurality of sub-models based on the plurality of hyper-parameters, wherein the CPU is further configured to update at least one sub-model from among the trained plurality of sub-models and at least one hyper-parameter corresponding to the updated at least one sub-model, wherein the plurality of sub-models are trained for a first predetermined number of epochs, wherein, during each epoch of the first predetermined number of epochs, the plurality of storage devices are further configured to process an original dataset based on the plurality of hyper-parameters to generate a plurality of preprocessed datasets corresponding to the plurality of hyper-parameters; and wherein, during the each epoch, the plurality of GPUs are further configured to train the plurality of sub-models based on the plurality of preprocessed datasets.

### BRIEF DESCRIPTION OF THE DRAWINGS

The above and other aspects, features and advantages of certain embodiments of the present disclosure will be more apparent from the following detailed description taken in conjunction with the accompanying drawings, in which:

FIG. 1 is a block diagram illustrating an electronic device according to some example embodiments;

FIG. 2 is a block diagram illustrating a storage device of FIG. 1 according to some example embodiments;

FIG. 3 is a flowchart illustrating a method for automatic data augmentation (AutoAugment) according to some example embodiments;

FIG. 4 is a flowchart illustrating a process of training each of sub-models with a first predetermined number of epochs according to some example embodiments;

FIG. 5 is a flowchart illustrating a process of training each of the sub-models during one epoch according to some example embodiments;

FIG. 6 is a flowchart illustrating a process of updating the sub-models and hyper-parameters according to some example embodiments;

FIG. 7 is a flowchart illustrating a process of transmitting data among the CPU, the storage devices and the GPUs according to some example embodiments;

FIG. 8 is a diagram of a system to which a storage device is applied, according to an embodiment;

FIG. 9 is a block diagram illustrating a host storage system according to some example embodiments;

FIG. 10 is a diagram of a UFS system according to an embodiment; and

FIG. 11 is a diagram of a data center to which a memory device is applied, according to an embodiment of the invention.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure. For example, the sequences of operations described herein are merely examples, and embodiments are not limited to the particular examples described herein, and may be changed as will be apparent after an understanding of the disclosure, with the exception of operations necessarily occurring in a certain order. Also, descriptions of features that are known in the art may be omitted for increased clarity and conciseness.

The features described herein may be embodied in different forms, and are not to be construed as being limited to the particular examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms such as “first” and “second” may be used to explain various components, the components are not limited to the terms. These terms should be used only to distinguish one component from another component. For example, a “first” component may be referred to as a “second” component, or similarly, and the “second” component may be referred to as the “first”component within the scope of the present disclosure.

It will be understood that when a component is referred to as being “connected to” another component, the component may be directly connected or coupled to the other component, or intervening components may be present.

As used herein, the singular forms “a”, “an”, and “the” are intended to include the plural forms as well, unless the context clearly indicates otherwise. It should be further understood that the terms “comprises” and/or “comprising,” as used herein, specify the presence of stated features, integers, steps, operations, elements, components or a combination thereof, and do not preclude the presence or addition of one or more other features, integers, steps, operations, elements, components, and/or groups thereof.

Unless otherwise defined, all terms including technical or scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals assigned to the elements in the drawings, it should be noted that the same elements will be designated by the same reference numerals, and redundant descriptions thereof will be omitted.

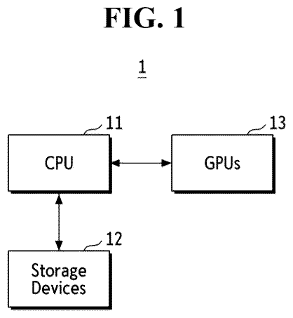

FIG. 1 is a block diagram illustrating an electronic device according to some example embodiments.

The electronic device 1 according to various example embodiments of the present disclosure may include, for example, a mobile phone, a tablet personal computer (PC), a personal digital assistant (PDA), etc. However, embodiments are not limited thereto, and the electronic device according to the present disclosure may be any electronic device having a function of image processing.

As is shown in FIG. 1, the electronic device 1 may include a central processing unit (CPU) 11, a plurality of storage devices 12, and a plurality of graphics processing units (GPUs) 13.

According to an example embodiment, the CPU 11 may determine a plurality of hyper-parameters corresponding to a plurality of sub-models. The hyper-parameters may represent strategies for performing data augmentation on images.

For example, each hyper-parameter may include a plurality of preprocessing operators corresponding to a plurality types of image processes, and each preprocessing operator may include a first element indicating one image process from among the plurality of types of image processes, a second element indicating a ratio of amount of data on which the one image process is performed to a predetermined batch size, and a third element indicating an extent to which the one image process is performed.

For example, the plurality of types of image processes may include at least one of cropping, equalization, rotation, translation, inversion, automatic contrast, overexposure, posterization, sharpening, color change, contrast adjustment, brightness adjustment, cutout, etc. However, the examples are not limited thereto, and the plurality of types of image processes may also include other image processes.

As an example, the batch size may represent a size or amount of training data used to update weights of a sub-model once.

According to an example embodiment, the plurality of storage devices 12 and the plurality of GPUs 13 may train the plurality of sub-models based on the plurality of hyper-parameters. For example, the plurality of storage devices 12 and the plurality of GPUs 13 may train the plurality of sub-models for a first predetermined number of epochs. This may mean that, for example, the training of the plurality of sub-models may be performed by the plurality of GPUs 13 over a particular number of training epochs, and the particular number may be the first predetermined number.

According to an example embodiment, a number of the plurality of hyper-parameters may be equal to a number of the plurality of sub-models, so that a plurality of preprocessed datasets corresponding to the plurality of hyper-parameters may be used to train the plurality of sub-models.

According to an example embodiment, a number of the plurality of GPUs 13 may be equal to the number of the plurality of sub-models, so that the plurality of GPUs 13 may perform the training of the plurality of sub-models in parallel.

According to an example embodiment, a number of the plurality of storage devices 12 may be greater than the number of the plurality of sub-models, so that one or more storage devices 12 may be used to generate a preprocessed dataset for training one sub-model, thereby training the plurality of sub-models in parallel by the plurality of GPUs 13.

For example, each storage device 12 of the plurality of storage devices 12 may include a smart solid state drive (SSD). However, embodiments are not limited thereto, and the storage devices 12 may be other memories that may perform the image process.

For example, one epoch may correspond to or include performing a complete training on a sub-model once using all data included in a preprocessed dataset generated based on a hyper-parameter corresponding to the sub-model.

According to an example embodiment, in each of the first predetermined number of epochs, the plurality of storage devices 12 may perform preprocessing on an original dataset based on the plurality of hyper-parameters, to generate a plurality of preprocessed datasets corresponding to the plurality of hyper-parameters, and the plurality of GPUs 13 may train the plurality of sub-models based on the plurality of preprocessed datasets. Hereinafter, a storage device 12 which performs the preprocessing based on a hyper-parameter corresponding to a sub-model may be referred to as a storage device 12 corresponding to the hyper-parameter or the sub-model, and a GPU 13 which performs the training based on preprocessed dataset corresponding to the hyper-parameter corresponding to the sub-model may be referred to as a GPU 13 corresponding to the hyper-parameter or the sub-model.

According to an example embodiment, the CPU 11 may update at least one sub-model among the trained plurality of sub-models and at least one hyper-parameter corresponding to the at least one updated sub-model. In embodiments, the trained plurality of sub-models may be referred to as a plurality of trained sub-models.

For example, the at least one sub-model may include n worst sub-models from among the trained plurality of sub-models.

As an example, performance of each trained sub-model of the trained plurality of sub-models may be determined using the original dataset (or a training dataset different from the original dataset), and n sub-models having best performance among the trained plurality of sub-models may be determined as n optimum sub-models, and n sub-models having worst performance among the trained plurality of sub-models may be determined as n worst sub-models, where n may be an integer greater than or equal to 1 and smaller than (2N+1)/2, and N may represent a total number of the plurality of sub-models. For example, a performance of a sub-model may be determined based on at least one of a number of errors generated by the sub-model, and an accuracy of the sub-model.

As an example, the CPU 11 may update the n worst sub-models by replacing the n worst sub-models with the n optimum sub-models.

For example, the CPU 11 may determine n hyper-parameters corresponding to the n updated worst sub-models by exploring n hyper-parameters corresponding to the n optimum sub-models, to update the n hyper-parameters corresponding to the n updated worst sub-models. As an example, exploring a hyper-parameter may include increasing or decreasing at least one third element of at least one preprocessing operator among a plurality of preprocessing operators included in the hyper-parameter by a value within a predetermined range.

According to an example embodiment, the training and the updating may be repeated until a total number of training epochs applied to the plurality of sub-models is equal to a second predetermined number. For example, the second predetermined number may be greater than the first predetermined number. According to an example embodiment, the second predetermined number may be equal to a product of the first predetermined number and a value that is obtained by adding a number of repetitions of the training and the updating to two (“2”).

According to an example embodiment, the repeating of the training may include training the plurality of sub-models including the at least one updated sub-model for the first predetermined number of epochs. During each epoch, at least one storage device corresponding to the at least one sub-model among the plurality of storage devices 12 may perform the preprocessing on the original dataset based on the at least one updated hyper-parameter to generate at least one preprocessed dataset corresponding to the at least one updated hyper-parameter. In addition, during each epoch, remaining storage devices, other than the at least one storage device, from among the plurality of storage devices 12 may perform the preprocessing on the original dataset based on hyper-parameters that are not updated among the plurality of hyper-parameters to generate preprocessed datasets corresponding to the hyper-parameters that are not updated among the plurality of hyper-parameters respectively.

According to an example embodiment, the CPU 11 may determine a hyper-parameter corresponding to an optimum sub-model from among the trained plurality of sub-models after stopping the repeating of the training and the updating. For example, the determined hyper-parameter may represent an optimum strategy for performing the data augmentation on the images.

Compared to other approaches in which the preprocessing is performed by the GPUs, example embodiments of the present disclosure may perform the preprocessing using the storage devices, and may therefore allow the GPUs to continuously obtain data and perform the training, which may improve the efficiency of the training model, and increase the batch size used for training, thereby improving the effect of the training. Compared to other approaches in which the preprocessing is performed by the CPU, example embodiments of the present disclosure may allow input and output costs to be reduced, and may allow the CPU utilization to be reduced and the efficiency of the preprocessing to be improved, by performing the preprocessing through the storage devices. In addition, compared to the GPUs and CPU, the storage devices may consume less power while performing the preprocessing.

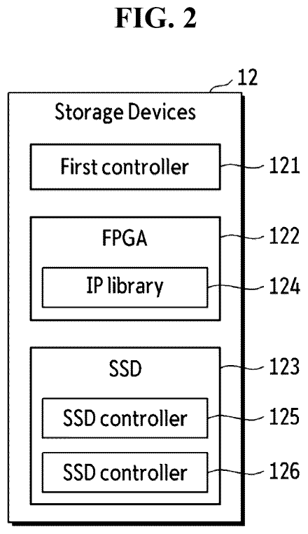

FIG. 2 is a block diagram illustrating a storage device of FIG. 1 according to some example embodiments.

The storage device 12 shown in FIG. 2 may be any one of the plurality of storage devices described with reference to FIG. 1, and the plurality of storage devices have the same configuration as each other.

As shown in FIG. 2, the storage device 12 may include a first controller 121, a field programmable gate array (FPGA) 122, and a solid-state drive (SSD) 123.

According to an example embodiment, the first controller 121 may receive a hyper-parameter (e.g., one hyper-parameter) from the CPU 11 and may control the FPGA 122 to perform the preprocessing on the original dataset based on the received hyper-parameter.

According to an example embodiment, the first controller 121 may determine a portion of original data, on which an image process is not to be performed, within the original dataset, based on the received hyper-parameter. According to embodiments, the portion of the original data may be referred to as a portion of the original dataset.

According to an example embodiment, the first controller 121 may divide the original dataset into a plurality of sub-datasets in units of a predetermined batch size, may sequentially select a sub-dataset from among the plurality of sub-datasets, and may randomly select at least one preprocessing operator from among a plurality of preprocessing operators included in the received hyper-parameter, each time one sub-dataset is selected.

According to an example embodiment, the first controller 121 may determine the portion of the original data by determining data, on which the image process is not to performed, in the selected sub-dataset, based on the at least one selected preprocessing operator. According to embodiments, the data in the selected sub-dataset may be referred to as a portion of the selected sub-dataset. For example, the first controller 121 may determine the portion of the original dataset by determining a portion of the selected sub-dataset on which the image process is not to be performed based on the at least one selected preprocessing operator.

According to an example embodiment, the FPGA 122 may perform the image process on remaining data, other than the portion of the original data, in the original dataset based on the received hyper-parameter (e.g., using an intellectual property (IP) library 124), to generate the processed data, and provide, using the CPU 11, the processed data to a GPU (e.g., a GPU corresponding to the received hyper-parameter) for training based on a preprocessed dataset corresponding to the received hyper-parameter among the plurality of GPUs 13. According to embodiments, the remaining data in the original dataset may be referred to as a remaining portion of the original dataset.

As an example, the preprocessed dataset corresponding to the received hyper-parameter may include the portion of the original data and the processed data.

According to an example embodiment, the FPGA 122 may generate the processed data by performing the image process on remaining data, other than data on which the image process is not to be performed, in the selected one sub-dataset, based on the at least one selected preprocessing operator. According to embodiments, the remaining data in the sub-dataset may be referred to as a remaining portion of the sub-dataset.

For example, when the first controller 121 randomly selects at least one preprocessing operator, the first controller 121 may determine data on which the image process is not to be performed, in the selected one sub-dataset based on at least one second element of the at least one selected preprocessing operator, and the FPGA 122 may perform at least one image process indicated by the first element of the at least one selected preprocessing operator on remaining data in the selected one sub-dataset based on at least one third element of the at least one selected preprocessing operator.

For example, based on one preprocessing operator being selected and first, second, and third elements of the selected preprocessing operator being rotation, ⅕, and 10°, respectively, the first controller 121 may determine that the image process is not to be performed on ⅘ of the data in the selected sub-dataset, and the FPGA 122 may rotate ⅕ of the data in the selected sub-dataset by 10°. However, examples are not limited thereto, and the preprocessing operator may include other first, second, and third elements.

For example, when two or more preprocessing operators are selected, image processes may be performed on remaining data, other than data on which the image processes are not to be performed, in the selected one sub-dataset in a predetermined order of the image processes.

According to embodiments, the image process may be performed on the sub-dataset using at least one preprocessing operator according to any desired method.

For example, the SSD 123 may include an SSD controller 125 and a NAND flash memory 126.

For example, NAND flash memory 126 may store the original dataset.

According to an example embodiment, the SSD controller 125 may provide the portion of the original data determined by the first controller 121 (for example, the data on which the image process is not to be performed, in each sub-dataset) to the GPU 13 corresponding to the received hyper-parameter via the CPU 11.

As an example, the first controller 121 and the SSD controller 125 may be collectively referred to as a controller of the storage device 12.

As an example, the first controller 121 may include a logic controller and a preprocessing controller. For example, the logic controller may receive the hyper-parameter, determine the portion of the original data, divide the original dataset, and select the sub-dataset and the preprocessing operator. The preprocessing controller may control the FPGA 122 to perform the image process.

In the example embodiments of the present disclosure, the efficiency of the preprocessing may be improved by performing the preprocessing through the FPGAs of the storage devices 12.

In the example embodiments of the present disclosure, before the GPUs 13 perform the training using the data (e.g., the data on which the image process is not to be performed in the one sub-dataset, and the data generated by performing the image process on remaining data in the one sub-dataset) having the batch size, the data having the batch size may be predetermined using the storage devices, which may improve the efficiency of training the model.

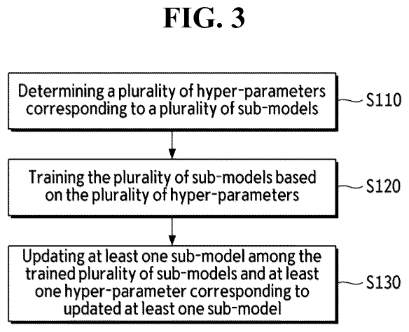

FIG. 3 is a flowchart illustrating a method for automatic data augmentation (which may be referred to as “AutoAugment”) according to some example embodiments.

As is shown in FIG. 3, at operation S110, a plurality of hyper-parameters corresponding to a plurality of sub-models may be determined by the CPU 11.

At operation S120, the plurality of sub-models may be trained based on the plurality of hyper-parameters, by the plurality of storage devices 12 and the plurality of GPUs 13.

According to an example embodiment, the training of the plurality of sub-models may include: training the plurality of sub-models for a first predetermined number of epochs.

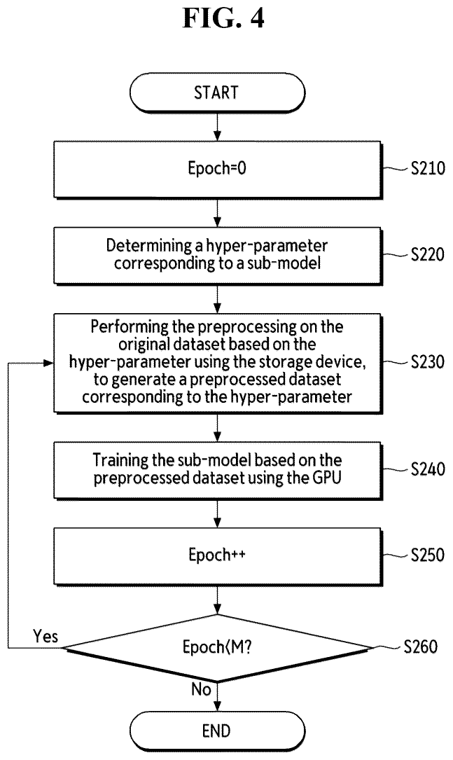

During each epoch of the first predetermined number of epochs, a preprocessing may be performed on an original dataset by the plurality of storage devices 12 based on the plurality of hyper-parameters, to generate a plurality of preprocessed datasets corresponding to the plurality of hyper-parameters; and the plurality of sub-models may be trained based on the plurality of preprocessed datasets, by the plurality of GPUs 13. Hereinafter, an example of a process of training each sub-model for the first predetermined number of epochs is described in detail with reference to FIG. 4.

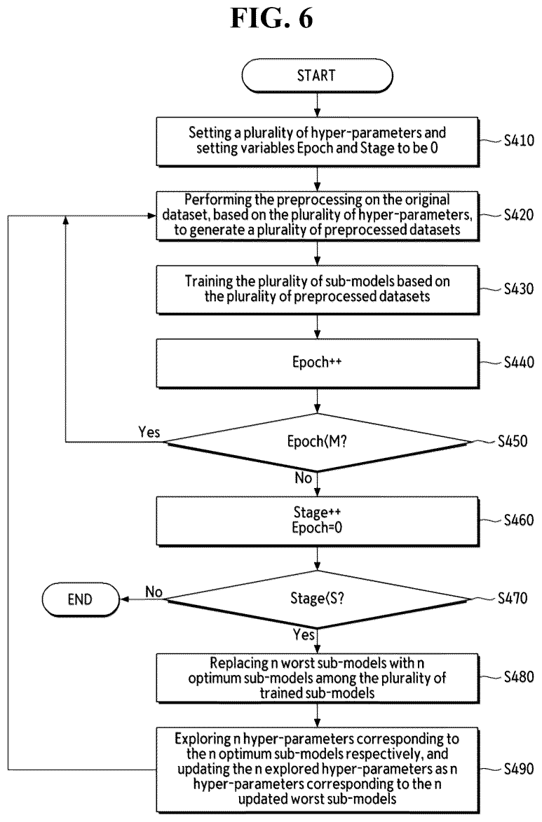

At operation S130, at least one sub-model among the trained plurality of sub-models may be updated, and at least one hyper-parameter corresponding to the updated at least one sub-model may be updated by the CPU 11. Hereinafter, an example of a process of updating the sub-models and the hyper-parameters is described in detail with reference to FIG. 6.

According to an example embodiment, a method for automatic data augmentation may further include repeating the training and the updating until a total number of training epochs for the plurality of sub-models is equal to a second predetermined number, and determining a hyper-parameter corresponding to an optimum sub-model among the trained plurality of sub-models, by the CPU, after stopping the repeating of the training and the updating.

FIG. 4 is a flowchart illustrating a process of training each of sub-models with a first predetermined number of epochs according to some example embodiments.

As shown in FIG. 4, at operation S210, a variable “Epoch” may be set to be zero (“0”).

At operation S220, a hyper-parameter corresponding to a sub-model may be determined by a controller of a storage device 12 corresponding to the sub-model or the hyper-parameter.

As an example, when the controller receives the hyper-parameter corresponding to the sub-model from the CPU 11, the controller may use the received hyper-parameter as the hyper-parameter corresponding to the sub-model; and when the controller does not receive the hyper-parameter corresponding to the sub-model from the CPU 11, the controller may use the hyper-parameter previously received from the CPU 11 as the hyper-parameter corresponding to the sub-model.

At operation S230, the preprocessing may be performed on the original dataset by the storage device 12 based on the hyper-parameter, to generate a preprocessed dataset corresponding to the hyper-parameter.

At operation S240, the sub-model may be trained by the GPU 13 corresponding to the hyper-parameter based on the preprocessed dataset.

At operation S250, the variable “Epoch” may be incremented (e.g., increased by one (“1”).

At operation S260, it may be determined whether the variable “Epoch” is equal to M (e.g., the first predetermined number). Based on the variable “Epoch” being less than M, the process may proceed to operation S230 to perform a next epoch of training on the sub-model. Based on the variable “Epoch” being greater than or equal to M (e.g., based on the number of the epochs of training the sub-model reaching the first predetermined number), the process of training the sub-model for the first predetermined number of epochs may end.

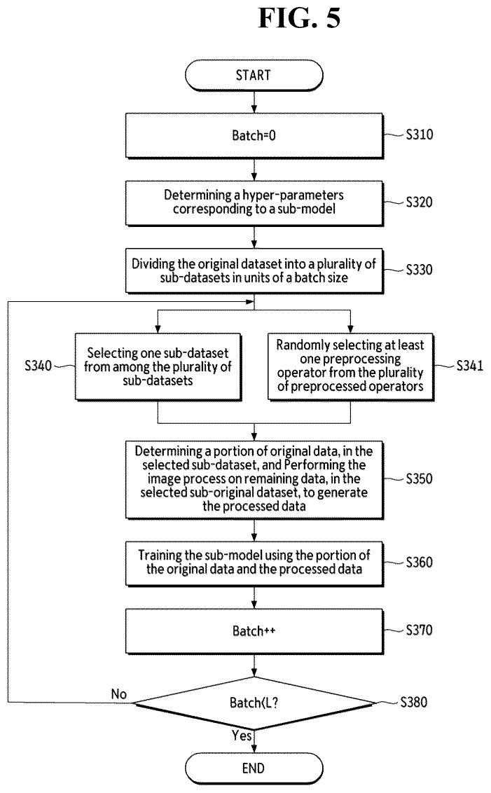

FIG. 5 is a flowchart illustrating a process of training each of the sub-models during one epoch according to some example embodiments.

As shown in FIG. 5, at operation S310, a variable “Batch” may be set to be zero (“0”).

At operation S320, a hyper-parameter corresponding to a sub-model may be determined by a controller of a storage device corresponding to the sub-model or the hyper-parameter.

As described above, when the controller receives the hyper-parameter corresponding to the sub-model from the CPU 11, the controller may use the received hyper-parameter as the hyper-parameter corresponding to the sub-model; and when the controller does not receive the hyper-parameter corresponding to the sub-model from the CPU 11, the controller may use the hyper-parameter previously received from the CPU 11 as the hyper-parameter corresponding to the sub-model.

At operation S330, the original dataset may be divided into a plurality of sub-datasets in units of a predetermined batch size, by the controller.

At operation S340, one sub-dataset may be selected from among the plurality of sub-datasets (e.g. sequentially or non-repetitively) by the controller. In addition, at operation S341, at least one preprocessing operator may be randomly selected from the plurality of preprocessing operators included in the hyper-parameter, by the controller.

At operation S350, the data on which the image process is not to be performed in the selected one sub-dataset may be determined by the controller based on the at least one selected preprocessing operator; and the image process may be performed on remaining data in the selected one sub-dataset based on the at least one selected preprocessing operator to generate the processed data, by an FPGA of the storage device.

At operation S360, the sub-model may be trained using the data, on which the image process is not to be performed, in the selected one sub-dataset and the processed data, by the GPU 13 corresponding to the hyper-parameter.

At operation S370, the variable “Batch” may be increased by one (“1”).

At operation S380, it may be determined whether the variable “Batch” is less than L (e.g., the number of the plurality of the sub-datasets).

When the variable Batch is less than L, the process may return to operations S340 and S350 to train the sub-model using a next sub-dataset. When the variable Batch is greater than or equal to L, the process of training the sub-model for one epoch may end.

FIG. 6 is a flowchart illustrating a process of updating the sub-models and hyper-parameters according to some example embodiments.

As shown in FIG. 6, at operation S410, a plurality of hyper-parameters corresponding to a plurality of sub-models may be set, and variables “Epoch” and “Stage” may be set to be zero (“0”), respectively, by the CPU 11.

At operation S420, the preprocessing may be performed on the original dataset, by the plurality of storage devices 12 based on the plurality of hyper-parameters, to generate a plurality of preprocessed datasets.

At operation S430, the plurality of sub-models may be trained by the plurality of GPUs 13 based on the plurality of preprocessed datasets.

When one epoch of training the plurality of sub-models based on the plurality of preprocessed datasets is completed, at operation S440, the variable “Epoch” may be incremented or increased by one (“1”).

At operation S450, it may be determined whether the variable “Epoch” is less than M. Based on the variable Epoch being less than M, the process may return to operation S420.

Based on the variable Epoch being greater than or equal to M, at operation S460, the variable “Stage” may be incremented or increased by one (“1”) and the variable “Epoch” may be set to be zero (“0”).

At operation S470, it may be determined whether the variable “Stage” is less than S. For example, S may be associated with a number of times that the updating of the sub-models and the hyper-parameters are to be repeated. As an example, the number of times for repeating the updating of the sub-models and the hyper-parameters may be S-2.

Based on the variable “Stage” being greater than or equal to S, the process of updating the sub-models and the hyper-parameters (or the method for the automatic data augmentation) may end.

Based on the variable “Stage” being less than S, at operation S480, n worst sub-models may be replaced with n optimum sub-models among the trained plurality of sub-models by the CPU 11, and at operation S490, n hyper-parameters corresponding to the n optimum sub-models may be explored respectively, and the n explored hyper-parameters may be updated as n hyper-parameters corresponding to the n updated worst sub-models, by the CPU 11. Then, the process may proceed to operation S420.

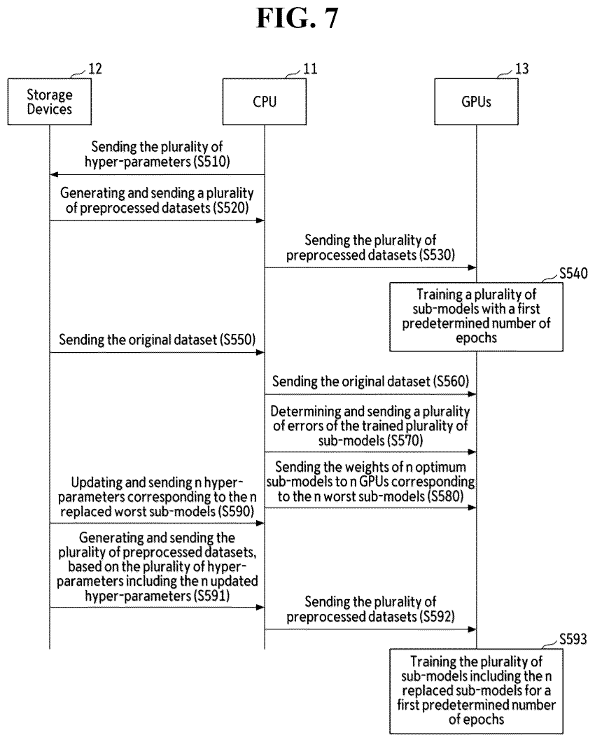

FIG. 7 is a flowchart illustrating a process of transmitting data among the CPU, the storage devices and the GPUs according to some example embodiments.

As shown in FIG. 7, at operation S510, the CPU 11 may set a plurality of hyper-parameters and send the plurality of hyper-parameters to the plurality of storage devices 12.

At operation S520, the plurality of storage devices 12 may perform a preprocessing on an original dataset based on the plurality of hyper-parameters to generate a plurality of preprocessed datasets corresponding to the plurality of hyper-parameters respectively, and send the plurality of preprocessed datasets to CPU 11.

At operation S530, the CPU 11 may send the plurality of preprocessed datasets to the plurality of GPUs 13.

At operation S540, the plurality of GPUs 13 may train a plurality of sub-models with a first predetermined number of epochs, based on the plurality of preprocessed datasets.

At operation S550, the plurality of storage devices 12 (or one of the plurality of storage devices 12) may send the original dataset to the CPU 11.

At operation S560, the CPU 11 may send the original dataset to the plurality of GPUs 13.

At operation S570, the plurality of GPUs 13 may determine a plurality of errors corresponding to the trained plurality of sub-models based on the original dataset, and send the plurality of errors to CPU 11.

At operation S580, the CPU 11 may determine the performance of the trained plurality of sub-models based on the plurality of errors, and determine n sub-models having best performance among the trained plurality of sub-models as n optimum sub-models, and n sub-models having worst performance among the trained plurality of sub-models as n worst sub-models. In addition, the CPU 11 may replace the n worst sub-models with the n optimum sub-models by replacing weights of the n worst sub-models with weights of the n optimum sub-models, and send the weights of n optimum sub-models to n GPUs 13 corresponding to the n worst sub-models.

At operation S590, the CPU 11 may explore n hyper-parameters corresponding to the n optimum sub-models respectively, and update the n explored hyper-parameters as n hyper-parameters corresponding to the n replaced worst sub-models. In addition, the CPU 11 may send the n updated hyper-parameters to n storage devices corresponding to the n updated hyper-parameters among the plurality of storage devices 12.

At operation S591, the plurality of storage devices 12 may perform the preprocessing on the original dataset based on the plurality of hyper-parameters including the n updated hyper-parameters to generate the plurality of preprocessed datasets corresponding to hyper-parameters respectively, and send the plurality of preprocessed datasets to the CPU 11.

At operation S592, the CPU 11 may send the plurality of preprocessed datasets to the plurality of GPUs 13.

At operation S593, the plurality of GPUs 13 may train the plurality of sub-models including the n replaced sub-models for a predetermined number of epochs based on the plurality of preprocessed datasets.

Afterwards, steps S550 to S593 may be repeated until the total number of epochs of training the plurality of sub-models is equal to the second predetermined number.

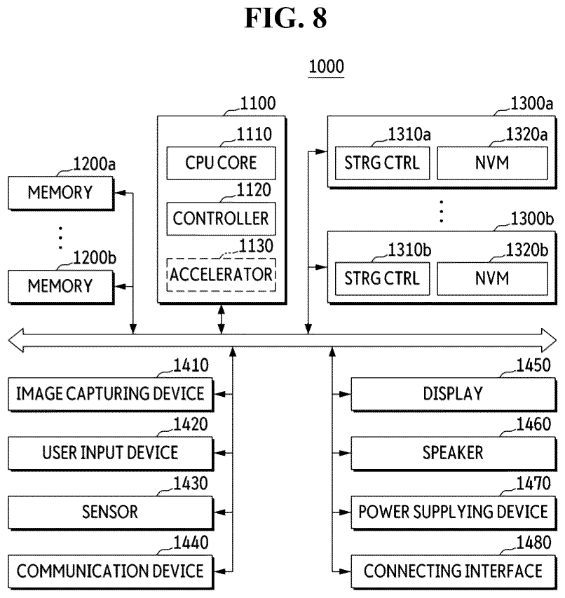

FIG. 8 is a diagram of a system 1000 to which a storage device may be applied, according to an embodiment. The system 1000 of FIG. 8 may be a mobile system, such as a portable communication terminal (e.g., a mobile phone), a smartphone, a tablet personal computer (PC), a wearable device, a healthcare device, or an Internet of things (IOT) device. However, the system 1000 of FIG. 8 is not necessarily limited to the mobile system and may be a PC, a laptop computer, a server, a media player, or an automotive device (e.g., a navigation device).

Referring to FIG. 8, the system 1000 may include a main processor 1100, memories (e.g., a memory 1200a and a memory 1200b), and storage devices (e.g., a storage device 1300a and a storage device 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. As an example, the main processor 1100 may include the above CPU 11. In some embodiments, the main processor 1100 may further include an accelerator 1130, which is a dedicated circuit for a high-speed data operation, such as an artificial intelligence (AI) data operation. The accelerator 1130 may include a GPU, a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (illustrated as “STRG CTRL”) 1310a and 1310b and non-volatile memories (NVMs) 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of SSDs or memory cards and may be removably combined with other components of the system 1000 through an interface, such as the connecting interface 1480 be described below. The storage devices 1300a and 1300b may be devices to which a standard protocol, such as a universal flash storage (UFS), an embedded multi-media card (eMMC), or a non-volatile memory express (NVMe), may be applied, without being limited thereto. As an example, the storage devices 1300a and 1300b may include the above plurality of storage devices 12.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

It should be understood to those skilled in the art that the system 1000 may further include the above CPU 11, although not shown.

As an example, there is provided a system (e.g., the system 1000) to which a plurality of storage devices is applied, including: a main processor (e.g., the processor 1100); memories (e.g., the memory 1200a and the memory 1200b); the storage devices (e.g., the storage device 1300a and the storage device 1300b); and GPUs, wherein the host device includes at least the main processor (e.g., the main processor 1100) and the memories (e.g., the memory 1200a and the memory 1200b).

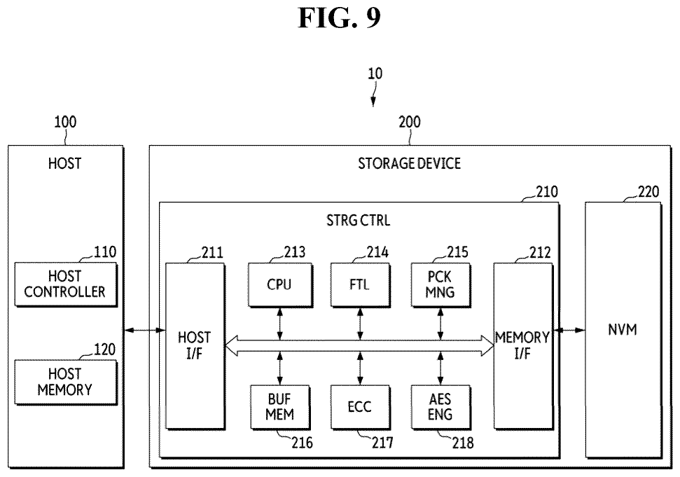

FIG. 9 is a block diagram illustrating a host storage system 10 according to some example embodiments.

The host storage system 10 may include a host 100 and a storage device 200. Further, the storage device 200 may include a storage controller 210 and an NVM 220. According to an example embodiment, the host 100 may include a host controller 110 and a host memory 120. The host memory 120 may serve as a buffer memory configured to temporarily store data to be transmitted to the storage device 200 or data received from the storage device 200. For example, the host 100 may further include the CPU 11 and GPUs 13 described above.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other types of NVMs. For example, the storage device 200 may include magnetic RAM (MRAM), spin-transfer torque MRAM, conductive bridging RAM (CBRAM), ferroelectric RAM (FRAM), PRAM, RRAM, and various other types of memories. For example, the storage device 200 may include the above plurality of storage devices 12.

According to an embodiment, the host controller 110 and the host memory 120 may be implemented as separate semiconductor chips. Alternatively, in some embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

As shown in FIG. 9, the storage controller 210 may include a host interface (IF) 211, a memory interface 212, and a CPU 213. Further, the storage controllers 210 may further include a flash translation layer (FTL) 214, a packet manager 215 (illustrated as “PCK MNG”), a buffer memory 216 (illustrated as “BUF MEM”), an error correction code engine 217 (illustrated as “ECC ENG”), and an advanced encryption standard engine 218 (illustrated as “AES ENG”).

According to an embodiment of the present disclosure, provided are a host storage system (e.g., the host storage system 10) including a host (e.g., the host 100) and a storage device (e.g., the storage device 200).

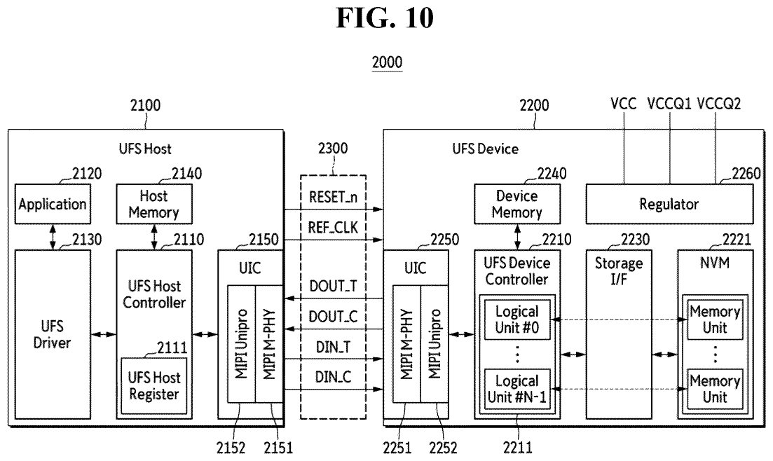

FIG. 10 is a diagram of a UFS system 2000 according to an embodiment. The UFS system 2000 may be a system conforming to a UFS standard announced by Joint Electron Device Engineering Council (JEDEC) and may include a UFS host 2100, a UFS device 2200, and a UFS interface 2300. The above description of the system 1000 of FIG. 8 may also be applied to the UFS system 2000 of FIG. 10 within a range that does not conflict with the following description of FIG. 10.

Referring to FIG. 10, the UFS host 2100 may be connected to the UFS device 2200 through the UFS interface 2300. When the main processor 1100 of FIG. 8 is an AP, the UFS host 2100 may be implemented as a portion of the AP. The UFS host controller 2110 and the host memory 2140 may respectively correspond to the controller 1120 of the main processor 1100 and the memories 1200a and 1200b of FIG. 8. The UFS device 2200 may correspond to the storage device 1300a and 1300b of FIG. 8, and a UFS device controller 2210 and an NVM 2220 may respectively correspond to the storage controllers 1310a and 1310b and the NVMs 1320a and 1320b of FIG. 8. For example, the UFS device 2200 may include the above plurality of storage devices 12.

The UFS host 2100 may include a UFS host controller 2110, an application 2120, a UFS driver 2130, a host memory 2140, and a UFS interconnect (UIC) layer 2150. The UFS device 2200 may include the UFS device controller 2210, the NVM 2220, a storage interface 2230, a device memory 2240, a UIC layer 2250, and a regulator 2260. The NVM 2220 may include a plurality of memory units 2221. Although each of the memory units 2221 may include a V-NAND flash memory having a 2D structure or a 3D structure, each of the memory units 2221 may include another kind of NVM, such as PRAM and/or RRAM. The UFS device controller 2210 may be connected to the NVM 2220 through the storage interface 2230. The storage interface 2230 may be configured to comply with a standard protocol, such as Toggle or ONFI. For example, the UFS host 2100 may include the CPU 11 and GPUs 13 described above.

The application 2120 may refer to a program that wants to communicate with the UFS device 2200 to use functions of the UFS device 2200. The application 2120 may transmit input-output requests (IORs) to the UFS driver 2130 for input/output (I/O) operations on the UFS device 2200. The IORs may refer to a data read request, a data storage (or write) request, and/or a data erase (or discard) request, without being limited thereto.

The UFS driver 2130 may manage the UFS host controller 2110 through a UFS-host controller interface (UFS-HCl). The UFS driver 2130 may convert the IOR generated by the application 2120 into a UFS command defined by the UFS standard and transmit the UFS command to the UFS host controller 2110. One IOR may be converted into a plurality of UFS commands. Although the UFS command may basically be defined by an SCSI standard, the UFS command may be a command dedicated to the UFS standard.

The UFS host controller 2110 may transmit the UFS command converted by the UFS driver 2130 to the UIC layer 2250 of the UFS device 2200 through the UIC layer 2150 and the UFS interface 2300. During the transmission of the UFS command, a UFS host register 2111 of the UFS host controller 2110 may serve as a command queue (CQ).

The UIC layer 2150 on the side of the UFS host 2100 may include a mobile industry processor interface (MIPI) M-PHY 2151 and an MIPI UniPro 2152, and the UIC layer 2250 on the side of the UFS device 2200 may also include an MIPI M-PHY 2251 and an MIPI UniPro 2252.

The UFS interface 2300 may include a line configured to transmit a reference clock signal REF_CLK, a line configured to transmit a hardware reset signal RESET_n for the UFS device 2200, a pair of lines configured to transmit a pair of differential input signals DIN_t and DIN_c, and a pair of lines configured to transmit a pair of differential output signals DOUT_t and DOUT_c.

The UFS device controller 2210 may manage the NVM 2220 by using a logical unit (LU) 2211, which is a logical data storage unit. The number of LUs 2211 may be 8, without being limited thereto

Voltages VCC, VCCQ1, and VCCQ2 may be applied as power supply voltages to the UFS device 2200.

According to an embodiment of the present disclosure, there is provided a UFS system (e.g., the UFS system 2000) including: a UFS host (e.g., the UFS host 2100); a UFS device (e.g., the UFS device 2200); and a UFS interface (e.g., the UFS interface 2300) for a communication between the UFS host and the UFS device.

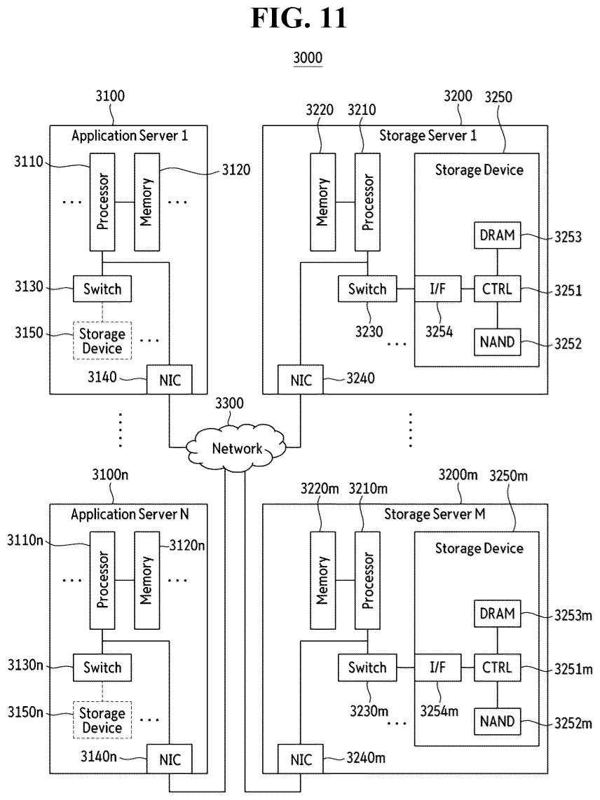

FIG. 11 is a diagram of a data center 3000 to which a memory device may be applied, according to an embodiment of the invention.

Referring to FIG. 11, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some embodiments, the numbers of processors 3210 and memories 3220 included in the storage server 3200 may be variously selected. In an embodiment, the processor 3210 and the memory 3220 may provide a processor-memory pair. In an embodiment, the number of processors 3210 may be different from the number of memories 3220. The processor 3210 may include a single-core processor or a multi-core processor. The above description of the storage server 3200 may be similarly applied to the application server 3100. In some embodiments, the application server 3100 may not include a storage device 3150. In some embodiments, a switch 3130 may be connected between the processor 3110 and the storage device 3150. The storage server 3200 may include at least one storage device 3250. In some embodiments, a switch 3230 may be connected between the processor 3210 and the storage device 3250. In some embodiments, the storage device 3250 may include a controller 3251 (illustrated as “CTRL”), a flash memory device (NAND) 3252, a DRAM 3253 and an interface 3254 (illustrated as “I/F”). The number of storage devices 3250 included in the storage server 3200 may be variously selected according to embodiments.

The application servers 3100 to 3100n may communicate with the storage servers 3200 to 3200m through a network 3300 (e.g., via Network Interface Cards (NICs) 3140 to 3140n and 3240 to 3240m). The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storage devices, block storage devices, or object storage devices according to an access method of the network 3300.

In an embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another embodiment, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

According to an embodiment of the present disclosure, there is provided a data center system (e.g., the data center 3000) including: a plurality of application servers (3100 to 3100n); and a plurality of storage servers (e.g., servers 3200 to 3200m), wherein at least one of the plurality of application servers includes the above CPU 11, the plurality of storage devices 12 and the plurality of GPUs 13.

The apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. As an example, a processor or computer may include, or may be connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described herein, but in other examples plurality of processors or computers may be used, or a processor or computer may include plurality of processing elements, or plurality of types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction plurality of-data (SIMD) multiprocessing, plurality of-instruction single-data (MISD) multiprocessing, and plurality of-instruction plurality of-data (MIMD) multiprocessing.

The methods that perform the operations described herein may be performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. As an example, the instructions or software may include machine code that is directly executed by the processor or computer, such as machine code produced by a compiler. In another example, the instructions or software may include higher-level code that is executed by the processor or computer using an interpreter. Programmers of ordinary skill in the art may readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the instructions.

While this disclosure includes specific examples, it will be apparent to one of ordinary skill in the art that various changes in form and details may be made in these examples without departing from the spirit and scope of the claims and their equivalents.

1. A method for automatic data augmentation comprising:
determining a plurality of hyper-parameters corresponding to a plurality of sub-models using a central processing unit (CPU);
training the plurality of sub-models based on the plurality of hyper-parameters using a plurality of storage devices and a plurality of graphics processing units (GPUs); and
updating at least one sub-model from among the trained plurality of sub-models and at least one hyper-parameter corresponding to the updated at least one sub-model using the CPU,
wherein the plurality of sub-models is trained for a first predetermined number of epochs, and
wherein, during each epoch from among the first predetermined number of epochs, the training comprises:
preprocessing an original dataset based on the plurality of hyper-parameters to generate a plurality of preprocessed datasets corresponding to the plurality of hyper-parameters using the plurality of storage devices; and
training the plurality of sub-models based on the plurality of preprocessed datasets using the plurality of GPUs.

2. The method of claim 1, wherein each storage device from among the plurality of storage devices comprises a controller and a field-programmable gate array (FPGA),
wherein, for each hyper-parameter of the plurality of hyper-parameters, the preprocessing comprises:
determining, by a controller of a storage device corresponding to the each hyper-parameter from among the plurality of storage devices, a portion of the original dataset on which an image process is not to be performed, based on the each hyper-parameter, and provide, using the CPU, the portion of the original dataset to a GPU from among the plurality of GPUs for training based on a preprocessed dataset corresponding to the each hyper-parameter, and
performing the image process on a remaining portion of the original dataset based on the hyper-parameter, to generate processed data, and
providing the processed data to the GPU using the CPU, by an FPGA of the storage device, and
wherein the preprocessed dataset comprises the portion of the original dataset and the processed data.

3. The method of claim 2, wherein the each hyper-parameter comprises a plurality of preprocessing operators corresponding to a plurality types of image processes,
wherein, for the each hyper-parameter, the preprocessing further comprises:
dividing, by the controller, the original dataset into a plurality of sub-datasets in units of a predetermined batch size,
sequentially selecting, by the controller, a sub-dataset from among the plurality of sub-datasets, and
randomly selecting, by the controller, at least one preprocessing operator from among the plurality of preprocessing operators based on the sub-dataset being selected,
wherein the determining of the portion of the original dataset comprises determining a portion of the sub-dataset on which the image process is not to be performed based on the at least one preprocessing operator, and
wherein the generating of the processed data comprises performing the image process on a remaining portion of the sub-dataset based on the at least one preprocessing operator.

4. The method of claim 1, further comprising:
repeating the training and the updating until a second predetermined number of epochs is reached; and
determining, by the CPU, a hyper-parameter corresponding to an optimum sub-model from among the trained plurality of sub-models, after the repeating of the training and the updating is stopped,
wherein the second predetermined number is greater than the first predetermined number.

5. The method of claim 4, wherein the repeating of the training comprises:
training the plurality of sub-models including the updated at least one sub-model for the first predetermined number of epochs; and
during each epoch:
preprocessing the original dataset based on the updated at least one hyper-parameter to generate at least one preprocessed dataset corresponding to the updated at least one hyper-parameter, using at least one storage device corresponding to the at least one sub-model from among the plurality of storage devices; and
preprocessing the original dataset based on hyper-parameters that are not updated from among the plurality of hyper-parameters to generate preprocessed datasets corresponding to the hyper-parameters that are not updated, using remaining storage devices from among the plurality of storage devices.

6. The method of claim 1, wherein the at least one sub-model comprises n worst sub-models from among the trained plurality of sub-models,
wherein the updating comprises:
replacing the n worst sub-models with n optimum sub-models from among the trained plurality of sub-models, where n is an integer that is greater than or equal to one (“1”) and less than (2N+1)/2, and where N represents a total number of the plurality of sub-models; and
exploring n hyper-parameters corresponding to the n optimum sub-models, to determine n hyper-parameters corresponding to the replaced n worst sub-models.

7. The method of claim 1, wherein each storage device of the plurality of storage devices comprises a smart solid state drive (SSD).

8. The method of claim 1, wherein the original dataset comprises an image dataset.

9. An electronic device comprising:
a central processing unit (CPU) configured to determine a plurality of hyper-parameters corresponding to a plurality of sub-models; and
a plurality of storage devices and a plurality of graphics processing units (GPUs) configured to train the plurality of sub-models based on the plurality of hyper-parameters,
wherein the CPU is further configured to update at least one sub-model from among the trained plurality of sub-models and at least one hyper-parameter corresponding to the updated at least one sub-model,
wherein the plurality of sub-models is trained for a first predetermined number of epochs, and
wherein, during each epoch from among the first predetermined number of epochs, the plurality of storage devices is further configured to perform preprocessing on an original dataset based on the plurality of hyper-parameters, to generate a plurality of preprocessed datasets corresponding to the plurality of hyper-parameters respectively, and
wherein, during the each epoch, the plurality of GPUs is further configured to train the plurality of sub-models based on the plurality of preprocessed datasets.

10. The electronic device of claim 9, wherein each of the plurality of storage devices includes a controller and a field-programmable gate array (FPGA),
wherein, for each hyper-parameter of the plurality of hyper-parameters, a controller of a storage device corresponding to the hyper-parameter among the plurality of storage devices is configured to determine a portion of the original dataset on which an image process is not to be performed based on the hyper-parameter, and to provide, using the CPU, the portion of the original dataset to a GPU from among the plurality of GPUs for training based on a preprocessed dataset corresponding to the hyper-parameter, and
wherein, for the each hyper-parameter, an FPGA of the storage device is configured to perform the image process on a remaining portion of the original dataset based on the hyper-parameter to generate processed data, and to provide, using the CPU, the processed data to the GPU, and
wherein the preprocessed dataset comprises the portion of the original dataset and the processed data.

11. The electronic device of claim 10, wherein each hyper-parameter of the plurality of hyper-parameters includes a plurality of preprocessing operators corresponding to a plurality of types of image processes respectively,
wherein, for the each hyper-parameter, the controller is further configured to:
divide the original dataset into a plurality of sub-datasets in units of a predetermined batch size,
sequentially select a sub-dataset from among the plurality of sub-datasets, and
randomly select at least one preprocessing operator from among the plurality of preprocessing operators, based on the sub-dataset being selected,
wherein the controller is further configured to determine the portion of the original dataset by determining a portion of the sub-dataset on which the image process is not to be performed based on the at least one preprocessing operator, and
wherein the FPGA is further configured to generate the processed data by performing the image process on a remaining portion of the sub-dataset based on the at least one preprocessing operator.

12. The electronic device of claim 9,
wherein the plurality of storage devices and the plurality of GPUs are further configured to repeat the training and the updating until a second predetermined number of epochs is reached,
wherein the CPU is further configured to determine a hyper-parameter corresponding to an optimum sub-model from among the trained plurality of sub-models after the repeating of the training and the updating is stopped, and
wherein the second predetermined number is greater than the first predetermined number.

13. The electronic device of claim 12, wherein to repeat the training, the plurality of storage devices and the plurality of GPUs are further configured to train the plurality of sub-models including the updated at least one sub-model for the first predetermined number of epochs,
wherein during the each epoch, at least one storage device corresponding to the at least one sub-model among the plurality of storage devices is configured to preprocess the original dataset based on the updated at least one hyper-parameter to generate at least one preprocessed dataset corresponding to the updated at least one hyper-parameter, and
wherein during the each epoch, remaining storage devices from among the plurality of storage devices are configured to preprocess the original dataset based on hyper-parameters that are not updated from among the plurality of hyper-parameters to generate preprocessed datasets corresponding to the hyper-parameters that are not updated.

14. The electronic device of claim 9, wherein the at least one sub-model comprises n worst sub-models from among the trained plurality of sub-models, where n is an integer greater than or equal to 1 and smaller than (2N+1)/2, and where N represents a total number of the plurality of sub-models,
wherein the CPU is further configured to:
update the n worst sub-models by replacing the n worst sub-models with n optimum sub-models among the trained plurality of sub-models, and
determine n hyper-parameters corresponding to the n updated worst sub-models by exploring n hyper-parameters corresponding to the n optimum sub-models, to update the n hyper-parameters corresponding to the updated n worst sub-models.

15. The electronic device of claim 9, wherein each of the plurality of storage devices comprises a smart solid state drive (SSD).

16. The electronic device of claim 9, wherein the original dataset comprises an image dataset.

17. A system to which storage devices are applied, comprising:
a main processor;
a memory;
a storage device; and
a plurality of graphics processing units (GPUs),
wherein the main processor is configured to determine a plurality of hyper-parameters corresponding to a plurality of sub-models,
wherein the storage device and the plurality of GPUs are configured to train the plurality of sub-models based on the plurality of hyper-parameters,
wherein the main processor is further configured to update at least one sub-model from among the trained plurality of sub-models and at least one hyper-parameter corresponding to the updated at least one sub-model, and
wherein the plurality of sub-models is trained for a first predetermined number of epochs,
wherein, during each epoch of the first predetermined number of epochs, the storage device is further configured to perform preprocessing on an original dataset based on the plurality of hyper-parameters to generate a plurality of preprocessed datasets corresponding to the plurality of hyper-parameters, and
wherein, during the each epoch, the plurality of GPUs is further configured to train the plurality of sub-models based on the plurality of preprocessed datasets.

18-20. (canceled)
